(19) United States
(12) Patent Application Publication
(10) Pub. No.: US 2021/0319415 A1
(43) Pub. Date: Oct. 14, 2021

(54) TWO-IN-ONE PROCESS FOR PAYMENTS AND ELECTRONIC DATA

(71) Applicant: Ivan Zadorozhny, San Jose, CA (US)

(72) Inventor: Ivan Zadorozhny, San Jose, CA (US)

(21) Appl. No.: 17/221,607

(22) Filed: Apr. 2, 2021

Related U.S. Application Data
(60) Provisional application No. 63/008,548, filed on Apr. 10, 2020.

(51) Int. Cl. G06Q 20/10; G06Q 20/38; G06Q 20/02; G06Q 40/02; H04L 9/32; H04L 9/08

(52) U.S. Cl. CPC G06Q 20/108; G06Q 20/3829; G06Q 20/023; G06Q 40/02; G06Q 20/0425; G06Q 20/102; H04L 9/3247; H04L 9/0816; G06Q 2220/00; G06Q 20/3825

(57) ABSTRACT

Computer-implemented methods, systems, and computer-readable media for enabling a sender of a payment or payment instrument to send to a recipient an electronic package EP along with the payment or payment instrument. In a method embodiment of the present invention, the sender creates and saves the EP within a third party repository EW (step 1); EW assigns values to a full access key EA for accessing EP, based upon input from the sender (step 2), and creates a text string memo EM from EA, where EM includes a second (partial access) key EK (step 3); the sender sends EPIT (EM, plus the payment or payment instrument), to the recipient via a communication channel (step 4); the recipient uses EM to access a first compartment of EW, where the recipient reconstitutes EA (step 5); and finally, the recipient uses EA to access EP from a second compartment of EW (step 6).

### RELATED APPLICATION

This patent application claims the priority benefit of commonly-owned U.S. provisional patent application 63/008,548 filed Apr. 10, 2020.

### TECHNICAL FIELD

The invention described herein pertains to the technical field of sending payments and ancillary information electronically from a sender to a recipient.

### BACKGROUND ART

Currently, a payment negotiable instrument PI (for example, a payment check) or a payment transfer PT (for example, a payment wire) is received by a payment recipient (Bob) separately from any electronic data files.

The invention described in this patent application is referred to as the “ezc process”. The ezc process converts a payment negotiable instrument PI or a payment transfer PT into a two-in-one item (called EPIT), comprising (1) the payment negotiable instrument (PI) or payment transfer (PT), and (2) an ezc memo (EM) in the form of a text string containing an access key (EA) for an electronic data package (EP) associated with that payment.

### DISCLOSURE OF INVENTION

The present patent application describes computer-implemented methods, systems, and computer-readable media for enabling a sender of a payment or payment instrument to send to a recipient an electronic package EP along with the payment or payment instrument. In a method embodiment of the present invention, the sender creates and saves the EP within a third party repository EW (step 1); EW assigns values to a full access key EA for accessing EP, based upon input from the sender (step 2), and creates a text string memo EM from EA, where EM includes a second (partial access) key EK (step 3); the sender sends EPIT (EM, plus the payment or payment instrument), to the recipient via a communication channel (step 4); the recipient uses EM to access a first compartment of EW, where the recipient reconstitutes EA (step 5); and finally, the recipient uses EA to access EP from a second compartment of EW (step 6).

### BRIEF DESCRIPTION OF THE DRAWINGS

These and other more detailed and specific objects and features of the present invention are more fully disclosed in the following specification, reference being had to the accompanying drawings, in which:

FIG. 1 is a flow diagram illustrating a method embodiment of the present invention.

FIG. 2 is a table that illustrates the embodiment of FIG. 1 with a focus on items EW and CC.

FIG. 3 is a block diagram that illustrates the embodiment of FIG. 1.

FIG. 4 is a set of four blocks that illustrate relationships among several of the important items of the present invention.

### GLOSSARY

As used herein, the following terms have the following meanings:

Alice=A sender of a payment or payment instrument from herself to Bob, where the payment or payment instrument is EPIT. Alice may be one of three separate entities: a creator of an Electronic Data Files Package (EP), a sender of EPIT to Bob, or a Payor of EPIT to Bob. Alice is present and acting in the first three steps of the six-step ezc process. Alice can be a computer, algorithm, or human.

Bob=A recipient of a payment or payment instrument from Alice, where the payment or payment instrument is EPIT. Bob may be one of three separate entities: a recipient of EPIT from Alice, a non-Alice retriever of EP from EW, or a payee of EPIT from Alice. Bob is present and acting in the last three steps of the six-step ezc process. Bob can be a computer, algorithm, or human.

CC=Communication Channel. EW can be used as a communication channel CC. An example of a communication channel is a portion or entirety of a payment transfer (wire transfer, ACH payment transfer, bank or other financial institution transfer, memo on a negotiable payment check, or memo on a negotiable payment eCheck); or a mobile, desktop, or online version of any one or more of the following items of software or services: mobile text, SMS, mobile data, e-mail, “snail mail” (slow paper mail sent via the postal service of a country or countries), photo, video, instant messenger service, payment transmitter such as bank or other financial institution or Paypal, bill pay service such as Bill.com, or Zelle, or accounting software such as QuickBooks or Oracle.

EA=ezc access key, which is a necessary and sufficient key to access a specific EP. The EA is created by Alice for Bob. The EA is revealed to Bob by using EK and RK. Each EA is unique for each LP. The EA has three parts: EA=EK+RK+EWR.

EK=ezc key, a key created by EW. The creation by Alice of the RK and EWR triggers the creation of the EK by EW. The EK is a part of BA. The EA is created by the cooperation of Alice and the EW. The EK can be assigned values by means of the EW generating a random character string.

EM=ezc memo. The EM is a text string and includes two items: the EK and the LP. The LP points to the location of the EW. The LP and the EK can be separated by a separator S. The LP and EK can be clearly identified by notational convention: an EM example in quotes is as follows “Lock: ezc.biz.Key:123456789abc”. In the EM, the LP is optional, but the EK must exist.

### Examples of EM's

1. ezc.biz#123abcdefg

2. www.ezc.fvi#123abcdefg

3. www.ezc.biz#123abcdefg

4. Bill.com#123abcdefg

5. www.Chase.com#123abcdefg

6. www.Chase.com/123abcdefg

7. Chase ePkg/123abcdefg

8. Chase ePkg.com.123abcdefg

EMM=“EM Mode” is the way/method the EM is presented by Alice to Bob. There are three EMM's:

(1) Wire/ACH (completed/settled payment: cash transferred from A to B) mode

(2) ECheck (Electronic Negotiable Instrument) mode

(3) Paper Check (Paper Negotiable Instrument) mode.

For the Electronic Negotiable Instrument mode and the Paper Negotiable Instrument mode, Bob receives EM before the negotiable instrument is cashed. This allows Bob to access EP before cashing the negotiable instrument.

EMF=EM format.

### Examples of EMF's

1. Webpage

2. Weblink

3. LP&S&EK

4. EK&S&EK

EP=electronic package. Alice creates and saves the EP. Examples of an EP include an online sharable space, electronic file(s), redirection to a Webpage, text string, and/or password. The EP contains electronic information pertinent or ancillary to the EPIT. The EP can be thought of as an electronic data attachment to an EPIT.

EPI=Ezc payment instrument. A PI that contains an EM.

EPT=Ezc payment transfer. A PT that contains an EM.

EPIT=The EPI or EPT.

EW=ezc process software, such as a stand-alone Website, or a software application that may be part of larger software, such as an accounting software, a bill pay service, bank or other financial institution portal software, payment generating software, etc. “Payment generating software” includes software that creates/triggers a bank or other financial institution (or payment transmitter) payment or transfer. “Payment generating software” also includes software that creates a payment instrument PI. Examples of payment instruments PI (payment negotiable instruments) include an eCheck, bank or other financial institution check, and traveler's check. The EW has multiple functions: it creates EP, EA, EK, and EM. The EW stores the EP for later access by Bob. The EW allows for Bob to retrieve the EP via the EA.

### Examples of EW's

1. www.ezc.biz

2. ChaseQuickPay

3. Bill.com

4. QuickBooks

5. Oracle

EWR=The EWR is an additional optional verification process that may be required by Alice and is a part of the EA. For example, the EWR may be a requirement to confirm the recipient's access to a specific e-mail address or telephone number via a verification code sent by the EW to that e-mail address.

LP=an online location pointer, which points to the online location of the EW in order to facilitate Bob's access to the EW. For example, LP can be a Webpage.

### Examples of LP's

1. www.ezc.biz

2. ChaseQuickPay

3. Bill.com

Memo=a memorandum in the form of a character string.

PI=payment instrument. A payment negotiable instrument, e.g., an eCheck or a common payment paper check.

PIT=A PI or PT.

PIT Memo=payment or payment negotiable instrument memo character string in a memo/notes/description field of a PIT.

PT=payment transfer. A completed funds or cash transfer from Alice to Bob. An electronic payment, e.g., a wire transfer, ACH, or EFT.

PTR=a payment transmitter: for example, a thrift bank or other financial institution, Paypal, or similar.

RK=the recipient key, which both Alice and Bob know in advance.

S=a separator between the LP and EK in the EM. Examples: EM=EK&S&LP and EM=LP&S&EK. S can be a non-alphanumeric special character separator, such as one or more of the following: ,.#/|}{@$*# etc.

### DETAILED DESCRIPTION OF PREFERRED EMBODIMENTS

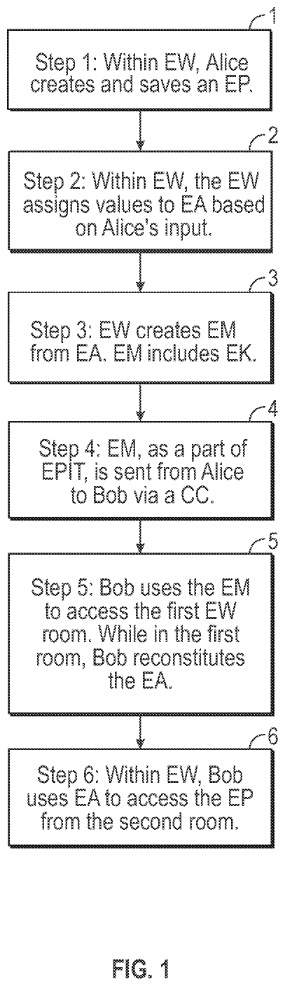

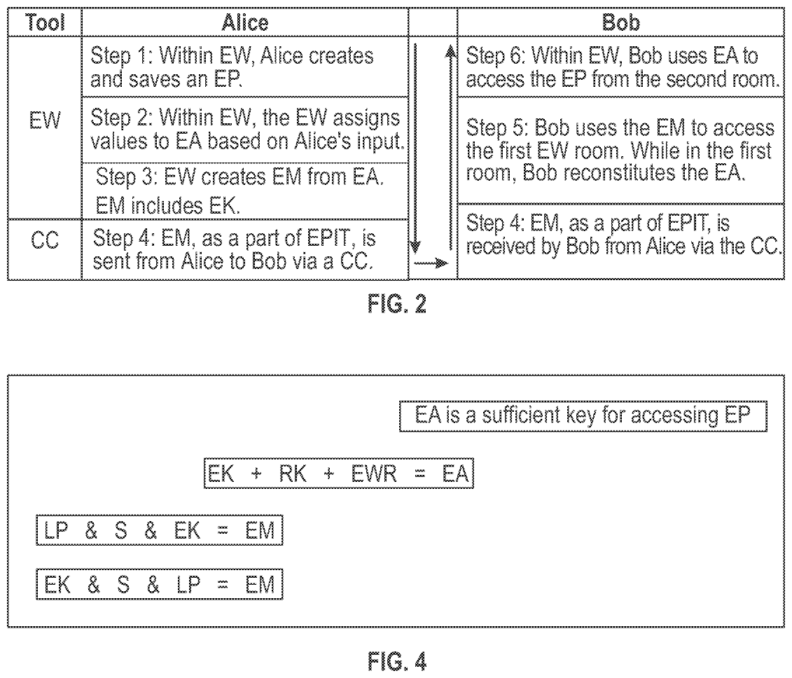

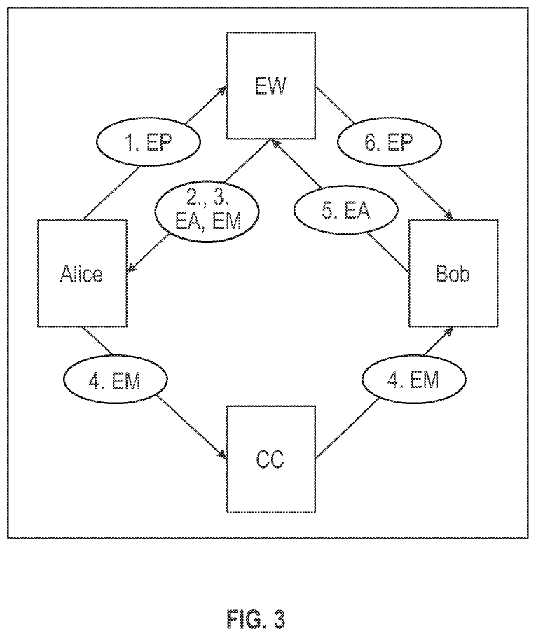

FIG. 1 illustrates six method steps of the ezc process. Step 1 is a prerequisite for step 2. Step 2 is a prerequisite for step 3. Step 3 is a prerequisite for step 4. Step 4 is a prerequisite for step 5. Step 5 is a prerequisite for step 6.

In order for Bob to access the EP, Bob needs to know the entire EA. The EP is located in an online secured space (virtual room). There are two rooms in the ezc process. Both rooms (compartments, locations) are within EW. The EP is located in the second room. The access to the second room is possible only from the first room. Bob gains access to the first room with the EM, which contains the EK. The EK is a part of the EA. While in the first room. Bob gains access to the second room by entering the remainder of the EA, namely the RK, and by executing the EWR if the optional EWR is present.

Description of the Six Steps of FIG. 1
Step 1: Within EW, Alice creates and saves an EP.
Step 2: Within EW, the EW assigns values to EA based on Alice's input.
Step 3: EW creates EM from EA. EM includes EK.
Step 4: EM, as a part of EPIT, is sent from Alice to Bob via a CC.
Step 5: Bob uses the EM to access the first EW room. While in the first room, Bob reconstitutes the EA.
Step 6: Within EW, Bob uses EA to access the EP from the second room.

The above steps can be implemented in any combination of hardware, firmware, and/or software, e.g., in the form of modules. For example, one or two modules can perform both steps 2 and 3. When the above steps are implemented in software, the software can be embodied in the form of computer programming instructions resident on one or more computer-readable media, such as any combination of one or more hard disks, floppy disks, optical disks, thumb drives, etc.

### Description of Additional, Nuanced, Embodiments

With the ezc process described herein, an EPIT can have one or more associated electronic files within EP. The EP can contain, for example, a detailed payment description and/or remittance instructions regarding how to apply the payment.

EP can be thought of as a payment “attachment” (like an e-mail attachment) arriving into Bob's possession at the same time as the EPIT, effectively creating a two-in-one process.

Alice creates the EP comprising data files stored on the EW. At EW, Alice optionally seals the EP, e.g., by affixing Alice's digital signature to the EP. “Sealed” means that no more EP modifications can be made by Alice.

Alice decides what information goes into the EA. This EA information may include one or more of a payment recipient payment routing number, a SWIFT code, and/or a payment recipient payment bank or other financial institution account number. For a PT where the CC is a payment transmitter institution like Paypal or another payment transmitter (PTR), this EA information may also include a payment recipient payment PTR official name, and/or a payment recipient's PTR payment account number/name.

Alice chooses the EA parts, which may include the following: the payment receiver routing number, the payment receiver bank or other financial institution account number, the payment amount, payment currency, the payment origination date, and the sender payment transmission institution (e.g., a bank or other financial institution, credit union, Paypal, or another PTR institution).

EW and Alice together combine the EK with the LP to form the EM as a character (text) string that can comprise alphanumeric and special characters. Preferably, the string is compiled in the following payment memo text string format (EMF):

LP&S&EK=EM
Example 1:
   ezc.biz#123abcdefg
Example 2:
   ezc.fyi#123abcdefg
Example 3:
   www.ezc.biz#123abcdefg
In the above examples, the hash character “#” is S, and the text string “123abcdefg” is the EK.

If the EM is within PT, the EM is transmitted to Bob by a payment transmitter (e.g., a bank or other financial institution) at the same time the payment transmitter PTR transmits the electronic payment EPT to Bob. Bob receives the EPT at the same time the EM arrives in Bob's payment transmitter account (e.g., payment and memo arrive simultaneously in Bob's bank or other financial institution account transaction list). In order to access the EP, Bob extracts EK from the EM. Bob then reconstitutes the EA parts: EK, RK, and the optional EWR. Bob uses EM to locate the “gate” into the first room and uses EK to access the first room. Bob then uses EA to access the EP located in the second room of the EW.

### Benefits and Advantages of the Present Invention

Currently, a payment negotiable instrument PI (for example, a payment check) or a payment transfer PT (for example, a payment wire) is received by a payment recipient (Bob) separately from any electronic data files. The electronic data files are usually sent separately via e-mail to the payment recipient Bob. These electronic data files may contain information related to the payment. Both a payment negotiable instrument PI and a payment transfer PT have a text string payment memo field. The present invention creates a process (called the ezc process herein) that uses the payment memo field in a specific way, which eliminates the use of e-mail for the transmission of the electronic data files. The ezc process converts a payment negotiable instrument PI or payment transfer PT into a two-in-one item (called EPIT), comprising (1) the payment negotiable instrument PI or payment transfer PT and (2) an EM. The EM is sufficient for the intended EP-recipient Bob to reconstitute an access key EA for an electronic data “attachment” EP to that EPIT. The ezc process payment memo field text character string allows Bob to access the electronic data EP (for example, a data file or files). With the ezc process, a payment negotiable instrument PI (for example, a payment check) or a payment transfer PT (for example, a payment wire) is received by a payment recipient Bob “simultaneously” with any electronic data files EP. The receipt of EPIT by Bob eliminates Bob's need to communicate with the sender Alice for the purpose of accessing the electronic data files EP.

In order for an EM to be useful, it needs to direct the EM recipient Bob to the online location EW, where the EM is used to unlock the EP.

The EM includes the key EK and a LP to the Website, Webpage, Weblink, or other EP retrieval service EW.

While using EW, Alice creates an EP and an EA. The EM provides enough information for Bob to access the EP at EW.
1. The ezc process allows for Bob to track a specific EP and/or EPIT in real time. It is possible to track the EP access attempts. The EK can be viewed as a tracking code, while LP can be viewed as a virtual pickup location.
2. No registration or creation of a user account is required by Alice or by Bob.
3. Bob's e-mail address access is not required to be part of the EA. Alice can request an access by Bob to a specific e-mail address (or telephone number or device). This e-mail access can be confirmed by EW sending a duration-limited random code EWR. Bob will then be required to use this code before Bob is allowed to access the EP.

The above description is included to illustrate the operation of preferred embodiments, and is not meant to limit the scope of the invention. The scope of the invention is to be limited only by the following claims. From the above discussion, many variations will be apparent to one skilled in the art that would yet be encompassed by the spirit and scope of the present invention.

1. A computer-implemented method for an electronic repository to enable a sender of a payment or payment instrument to send to a recipient an electronic package along with the payment or payment instrument, said method comprising the steps of the repository:
receiving from the sender an electronic package created by the sender;
assigning, based upon input from the sender, values to a full access key EA for enabling the recipient to access the electronic package;
creating a text string memo EM from the EA;
conveying EM to the sender, whereby the sender is equipped to send EM, plus the payment or payment instrument, to the recipient via a communication channel;
allowing the recipient to use EM to access a first compartment of the repository, where the recipient is able to reconstitute EA; and
permitting the recipient to use EA to access the electronic package from a second compartment of the repository.

2. The method of claim 1 where the sender is a computer, algorithm, or human.

3. The method of claim 1 where the recipient is a computer, algorithm, or human.

4. The method of claim 1 where the sender is a creator of the electronic package, a sender of an EPIT to the recipient, or a payor of an EPIT to the recipient, where:
EPIT is a payment instrument or payment transfer that contains an EM.

5. The method of claim 1 where the recipient is a recipient of an EPIT from the sender, a non-sender retriever of the electronic package from the repository, or a payee of an EPIT from the sender, where:
EPIT is a payment instrument or payment transfer that contains an EM.

6. The method of claim 1 where the communication channel is at least a portion of a payment transfer; or a mobile, desktop, or online version of a communication service.

7. The method of claim 6 wherein the communication channel is from the group consisting of:
wire transfer;
ACH payment transfer;
bank or other financial institution transfer;
memo on a negotiable payment check;
memo on a negotiable payment eCheck;
mobile text;
SMS;
mobile data;
e-mail;
snail mail;
photo;
video;
instant messenger service;
payment transmitter;
bill pay service; and
accounting software.

8. The method of claim 1 wherein EA comprises EK and RK, where:
EK is part of EM, and represents the first compartment; and
RK is-a recipient key known to both the sender and the recipient prior to executing the method of claim 1.

9. The method of claim 8 wherein EA further comprises EWR, where EWR is a verification process required by the sender in order for the recipient to access EA.

10. The method of claim 9 where EWR comprises a requirement to confirm the recipient's access to a specific e-mail address or telephone number via a verification code sent by the repository to said specific e-mail address or phone number.

11. The method of claim 1 where the sender seals the electronic package by affixing a digital signature of the sender to the electronic package.

12. An electronic repository configured to permit the sending of ancillary data and a payment or payment instrument to a recipient, said electronic repository comprising:
a module for assigning values to an electronic access key EA based upon input from a sender of the payment or payment instrument;
a module for creating an electronic memo EM from EA;
a first compartment configured to enable the recipient to reconstitute EA after accessing the first compartment using EM; and
a second compartment configured to enable the recipient to use EA to access the ancillary data.

13. The electronic repository of claim 12 where the repository is from the group consisting of:
a stand-alone Website; and
software comprising accounting software, a bill pay service, bank or other financial institution portal software, or payment generating software.

14. The electronic repository of claim 12 where EM comprises EK, representing the first compartment, plus a location pointer LP to the repository.

15. The electronic repository of claim 14 where EK and the location pointer LP are separated by a non-alphanumeric special character separator S.

16. The electronic repository of claim 14 where each EA is unique for each location pointer LP.

17. The electronic repository of claim 12 where EA comprises at least one of a payment recipient's payment routing number, a SWIFT code, and a payment bank or other financial institution account number of the payment or payment instrument.

18. The electronic repository of claim 14 where EK is assigned values by means of the electronic repository generating a random character string.

19. A computer-implemented method for enabling an electronic repository to send ancillary data and a payment or payment instrument to a recipient, said method comprising the steps of the electronic repository:
assigning values to an electronic access key EA based upon input from a sender of the payment or payment instrument;
creating an electronic memo EM from EA;
enabling the recipient to reconstitute EA after accessing a first compartment of the repository using EM; and
enabling the recipient to use EA to access the ancillary data from a second compartment of the repository.

20. At least one computer-readable medium containing computer program instructions for enabling an electronic repository to send ancillary data and a payment or payment instrument to a recipient, said computer instructions allowing the repository to:
assign values to an electronic access key EA based upon input from a sender of the payment or payment instrument;
enable the recipient to reconstitute EA after accessing a first compartment of the repository using EM; and
enable the recipient to use EA to access the ancillary data from a second compartment of the repository.
